(19) United States
(12) Patent Application Publication
(10) Pub. No.: US 2010/0202043 A1
(43) Pub. Date: Aug. 12, 2010

(54) SLIT-SCANNING CONFOCAL MICROSCOPE

(75) Inventor: Tomoko Ujike, Tokyo (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/541,858

(22) Filed: Aug. 14, 2009

Related U.S. Application Data
(63) Continuation of application No. PCT/JP2008/052123, filed on Feb. 8, 2008.

(30) Foreign Application Priority Data
Feb. 14, 2007 (JP) JP 2007-033397

(51) Int. Cl. G02B 21/06; G01N 21/64

(52) U.S. Cl. 359/385; 250/458.1

(57) ABSTRACT

Slit-scanning confocal microscopes are disclosed having a slit-like light source, an illumination optical system, and an imaging optical system. The illumination optical system forms an image of the light source on a sample. The imaging optical system forms an image of the illuminated sample on a line sensor. The line sensor is situated optically conjugate to the light source and receives light from the sample as reflected light, transmitted light, or fluorescence light. The slit-like light source is divided into unit light sources each having a size that is optically conjugate to a respective pixel of the line sensor.

### CROSS-REFERENCE TO RELATED APPLICATIONS

This application is a continuation of, and claims priority to and the benefit of, PCT/JP/2008/052123, filed on Feb. 8, 2008, and published as WO 2008/099778 on Aug. 21, 2008, which claims priority to and the benefit of Japan Patent Application No. 2007-033397, filed on Feb. 14, 2007, all of which being incorporated herein by reference in their respective entireties.

### TECHNICAL FIELD

The present disclosure pertains, inter alia, to slit-scanning confocal microscopes.

### BACKGROUND ART

In a conventional slit-scanning confocal microscope, light emitted from a light source passes through a first slit. An image of the first slit is used as scanning light that passes through a scanning optical system that forms an image of the first slit on a sample using an objective lens. Reflected light or fluorescence light from the sample passes back through the objective lens and scanning optical system to convert the reflected light or fluorescence light into non-scanning light. The reflected light or fluorescencet light passes through a second slit disposed optically conjugate with the first slit. The intensity of the light passing through the second slit is measured by a detector (line sensor) to obtain image data. A galvanic mirror or the like is used in the scanning optical system to perform one-dimensional scanning of light in a direction normal to the length direction of the slit.

It is not always necessary to utilize a scanning optical system. Alternatively, scanning may be performed by moving an integrally arranged light source, illumination optical system, imaging optical system, slits, or the like.

Detailed description of a laser confocal scanning microscope is given in Tsuruta, “Light Pencil,” chapter 5 of New Technology Communications, pp. 177-205. In the slit-scanning confocal microscope, a pinhole used in a laser confocal scanning microscope is replaced by a slit.

In a conventional confocal microscope, the sample is scanned with a beam of light from a pinhole-like light source. Only light that has passed through a pinhole, situated conjugate to the light source, is detected. Hence, this conventional confocal microscope has high resolving power in the depth dimension of the sample. However, images and image data are produced very slowly because the scanning is only two-dimensional using the very narrow beam from the pinhole.

To increase the speed of operation of a conventional laser confocal microscope using a scanned beam from a point light source, a slit-scanning confocal microscope can be used and are available. However, conventional slit-scanning confocal microscopes exhibit reduced resolution (lower resolving power) in the depth dimension of the sample.

The present invention addresses the shortcomings of conventional devices summarized above. The invention provides, inter alia, slit-scanning confocal microscopes having enhanced resolving power in the sample's depth dimension.

### DISCLOSURE OF THE INVENTION

A first embodiment for solving the problems summarized above is a slit-scanning confocal microscope that includes a slit-like light source, an illumination optical system, and an imaging optical system. The illumination optical system forms an image of the light source on a sample, and the imaging optical system forms an image of reflected light, transmitted light, or fluorescence light from the sample on a line sensor. The line sensor is disposed in a position that is optically conjugate with the light source. The light source is divided into multiple unit light sources. Each unit light source has a size and location that are optically conjugate with a respective pixel of the line sensor.

A second embodiment is similar to the first embodiment, but the light source is controlled such that the unit light sources are individually lit in a predetermined, ordered manner.

A third embodiment is similar to the second embodiment, but the light source is controlled such that the unit light sources adjacent to a lit unit light source are turned off, and unit light sources adjacent to an non-lit unit light source are lit.

A fourth embodiment is similar to the second or third embodiments but the light source is controlled such that the unit light sources that are lit and the unit light sources that are not lit are arranged alternatingly relative to each other.

A fifth embodiment is similar to any of the second, third, or fourth embodiments but includes a signal-operation unit. Assuming that Sa is an output signal obtained from a pixel in the line sensor when the unit light source that is conjugate with the pixel is lit, and assuming that Sb is an output signal obtained from the pixel in the line sensor when the unit light source that is conjugate with the pixel has been turned off, while the unit light sources on both sides of the turned-off unit light source are lit. A difference output signal (Sa−Sb) is used as a corrected output signal of the output signal Sa of the pixel in the line sensor.

### BRIEF DESCRIPTION OF THE DRAWINGS

FIG. 1(a) is a schematic diagram illustrating the principle of a slit-scanning confocal microscope according to an embodiment of the invention;

FIG. 1(b) is a view illustrating an array of unit light sources and a line sensor;

FIG. 2 is a view illustrating a relationship between unit light sources, sample regions and pixels in the line sensor;

FIG. 3 is a view illustrating a region of a sample irradiated with one unit light source;

FIG. 4 is a view illustrating a region of a sample whose information is obtained from a pixel of the line sensor in lighting a unit light source adjacent to the unit light source conjugated with the pixel; and

FIG. 5 is a view illustrating regions of a sample whose information is obtained from output signals.

### BEST MODE FOR CARRYING OUT THE INVENTION

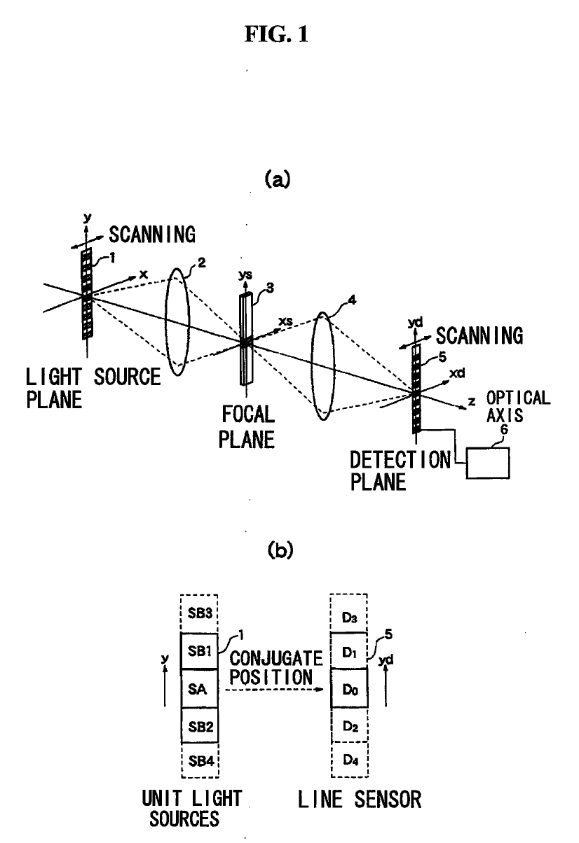

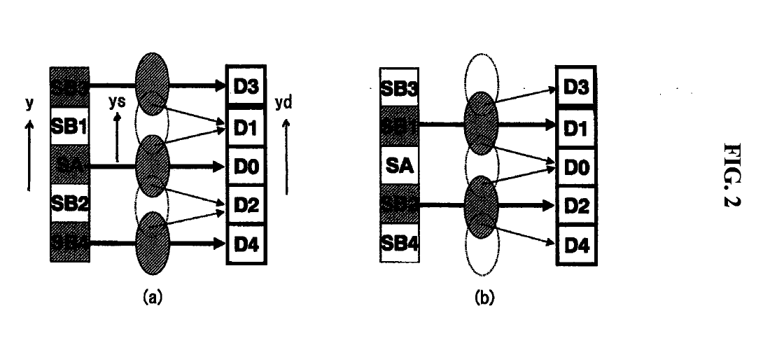

An embodiment of the present invention will be described below with reference to the drawings. FIG. 1(a) is a schematic diagram illustrating the principle of a slit-scanning confocal microscope according to a first embodiment. In FIG. 1(a), an optical-axis direction is arranged along a z-axis, a slit-length direction of the slit-like light source 1 is arranged along a y-axis, and a slit-width direction is set to an x-axis.

A light-source plane is defined by the slit-like light source 1 (which may be used as a secondary light source), and the plane is conjugate with the image plane on a sample 3. An illumination optical system 2 makes an image of the slit-like light source 1 on the image plane (xs-ys plane) on the sample 3 using light emitted from the slit-like light source 1. This light that is incident on the sample 3 can produce any of various types of light, including fluorescence light, reflected light, or transmitted light (transmitted light is illustrated in FIG. 1(a), by way of example) from an irradiated region of the sample 3. An imaging optical system 4 receives the light (fluorescence light, reflected light, and/or transmitted light) from the sample 3 and forms an image, on a line sensor 5, of the light produced by the sample. (Transmitted light is illustrated in FIG. 1(a) by way of example). The line sensor 5 defines an xd-yd plane that is conjugate to the xs-ys plane. A signal-operation unit (processor) 6 processes the output signal produced by the line sensor 5.

The position of the line sensor 5 is conjugate to the slit-like light source 1. The detection plane of the line sensor 5 is conjugate to the image plane. Therefore, light from the image plane (xs-ys plane) on the sample 3 is focused on the line sensor 5 (xd-yd plane). The sample 3 is scanned in the optical-axis direction and in the xs-direction to provide image data over the entire target sample region. Alternatively, the slit-like light source 1 may be moved in the x-axis direction and the line sensor 5 may be moved in the xd-axis direction while the conjugate relationship is maintained between the slit-like light source 1 and the line sensor 5.

FIG. 1(b) illustrates the positional relationship between the slit-like light source 1 and the pixels of the line sensor 5. The slit-like light source 1 is divided into multiple unit light sources. Each unit light source is sized and positioned so that it is optically conjugate to a respective pixel of the line sensor 5 via the illumination optical system 2 and the imaging optical system 4. FIG. 1(b) illustrates a situation in which a unit light source SA of the slit-like light source 1 is conjugate to a respective pixel D₀ of the line sensor 5. Similarly, the unit light source SB1 is conjugate to the pixel D₁, the unit light source SB2 is conjugate to the pixel D₂, the unit light source SB3 is conjugate to the pixel D₃, and the unit light source SB4 is conjugate to the pixel D₄. Thus, the slit-like light source 1 comprises multiple unit light sources that are conjugate to respective pixels of the line sensor 5.

FIGS. 2(a)-2(b) illustrate an exemplary relationship between the unit light sources, sample regions, and the pixels of the line sensor. The manner of indicating the slit-like light source and the pixels is similar to that used in FIG. 1(b). In FIGS. 2(a) and 2(b), unit light sources that are lit are denoted by hatching. That is, in FIG. 2(a), the unit light sources SA, SB3, and SB4 are lit, and the intervening light sources SB1 and SB2 are turned off. (The unit light sources SB1 and SB2 are adjacent the lit unit light source SA.) A controller (not shown) controls the turning on and off of the unit light sources. Respective illuminated regions on the sample, denoted by hatched ellipsoids in FIGS. 2(a) and 2(b), are detected by respective pixels that are conjugate to the respective lit unit light sources. Regions on the sample, denoted by broken-line ellipsoids in FIGS. 2(a) and 2(b), are areas that can be detected by respective pixels that are conjugate to respective non-lit unit light sources.

In FIG. 2(b), the unit light sources SB1 and SB2 are lit, and the unit light source SA between them is turned off. I.e., the unit light sources SA and SB3 adjacent the lit unit light source SB1 are turned off, and the unit light sources SA and SB4 adjacent the lit unit light source SB2 are turned off Thus, the slit light source 1 is controlled so as to provide the lighting condition shown in FIG. 2(a) and the lighting condition shown in FIG. 2(b). The sample 3 is scanned to obtain respective output signals associated with each of the lighting conditions shown in FIGS. 2(a) and 2(b). Alternatively, the sample 3 may be scanned in the x-axis direction by moving the slit-like light source to obtain the output signal.

Light propagation will be described with reference, for example, to the unit light source SA and the pixel D0. In the lighting condition shown in FIG. 2(a), in which the unit light source SA is lit, light from the illuminated region of the sample (indicated by the corresponding hatched ellipsoid) is incident on the pixel D0. This light is also partially incident on the pixels D1 and D2 adjacent the pixel D0. I.e., light in regions in which hatched ellipsoids and broken-line ellipsoids overlap each other is incident to the pixels D1 and D2.

Similarly, in the lighting condition shown in FIG. 2(b), portions of respective light emitted from the unit light sources SB1 and SB2 (including light in regions of overlap of the hatched ellipsoids and broken-line ellipsoids) are incident on the pixel D0. This is because light emitted from the unit light source is spread on the sample while the region that can be detected by the pixel D0 is also spread on the sample. I.e., when the unit light source SB1 is illuminated, light received by the pixel D0 includes not only light generated from that region except from the neighborhood of the image plane by the illumination of the unit light source SB1 but also a portion of the light generated from the region (except for the neighborhood of the image plane) by illumination of the unit light source SB2.

In the following description, it is assumed that Sa is an output signal supplied from the pixel D0 in the lighting condition shown in FIG. 2(a), i.e., whenever the unit light source SA is lit. The sample data expressed by the output signal Sa will be described below.

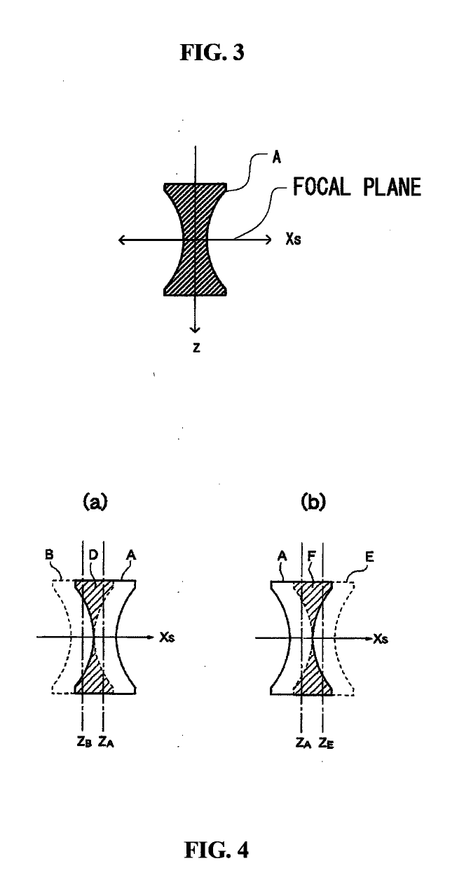

FIG. 3 shows a region A of the sample being irradiated with light emitted from the unit light source SA. Light from the region A is received mainly by the pixel D0 but is also received partially by the pixels D1 and D2.

The portion on the Xs-axis in the region A of FIG. 3 corresponds to the neighborhood of the image plane. Although the region A is maximally narrowed in the image plane (xs-ys plane) on the sample 3, the region A also widens in the z-axis direction. As described above, because a pinhole is not used in the slit-scanning confocal microscope, the resolution is lower in the depth dimension of the sample, and the sample-information region included in the output signal Sa overlaps the region A of the irradiated sample. The output signal Sa includes a portion of the light generated by the region (except in the neighborhood of the image plane) in the sample by the unit light source SA (i.e., the position distant from the image plane in the optical axis direction).

Then, the unit light sources SB1 and SB2 adjacent to the unit light source SA are lit, as illustrated in FIG. 2(b). At this point, it is assumed that Sb is an output signal of light received by the pixel D0. The sample information region expressed by the output signal Sb will be described with reference to FIG. 4.

In FIG. 4(a), a region A (Z_{A} is a center axis in the z-axis direction) indicated by a solid line corresponds to the region A of FIG. 3, and a region B (Z_{B} is a center axis in the z-axis direction) indicated by a broken line corresponds to the region irradiated by the unit light source SB1. As illustrated in FIG. 4(a), the region A and the region B overlap each other in the hatched region D.

Similarly, in FIG. 4(b), a region A (indicated by the solid line) corresponds to the region A of FIG. 3, and a region E (wherein Z_{E} is a center axis in the z-axis direction) indicated by a broken line corresponds to the region irradiated by the unit light source SB2. As illustrated in FIG. 4(b), the regions A and E overlap each other in the hatched region F.

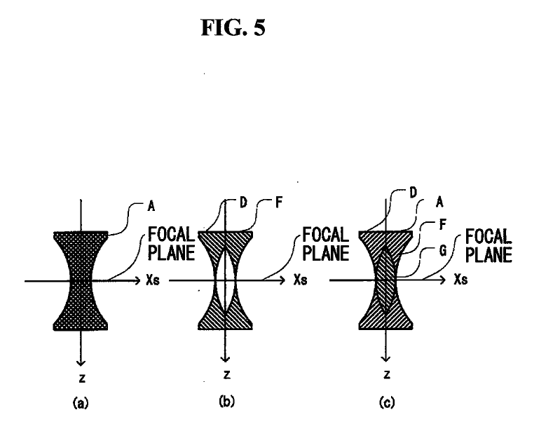

As described above, in the lighting situation shown in FIG. 2(b), respective light from the overlapping regions D and F on the sample are detected by the pixel D0 to produce the output signal Sb. I.e., as illustrated in FIG. 5(b), the sample data in the output signal Sb is a combination of respective information from the regions D and F in FIG. 4. The output signal Sb is considered to be substantially equivalent to the portion of light that is included in the output signal Sa and generated from the region, except in the neighborhood of the image plane, by irradiation of the unit light source SA.

Therefore, whenever a difference output signal (Sa−Sb) is obtained during operation, the difference output signal (Sa−Sb) includes information of a region G of FIG. 5(c). The region G is narrower in the z-direction than the region A of FIG. 5(a), wherein the region A is the sample-information region obtained during illumination of the unit light source SA. This means that the resolving power (resolution) in the sample-depth direction is enhanced. As a result, whenever an image is formed with the difference output signal as a corrected output signal of the pixel D0, the image having the higher resolution in the sample-depth direction can be obtained.

As illustrated in FIG. 2(a), the above-described processing is performed while the unit light sources of the slit-like light source 1 are controllably illuminated such that lit unit light sources and non-lit unit light sources are arranged in an alternating manner. Then, as illustrated in FIG. 2(b), in the slit-like light source 1 the lit unit light sources are turned off as the non-lit unit light sources are illuminated to perform the above-described processing. Then, whenever an image is formed by combining the output signals obtained in the two cases, the image having a higher resolution in the sample-depth direction can be obtained.

In the above description, the unit light sources of the slit-like light source 1 are arranged such that lit ones and turned-off ones are arranged alternatingly. However, this alternating arrangement is not always necessary. For example, the unit light sources can be discretely lit in any order, and the same advantageous effects are obtained when the difference output signal (Sa−Sb) is used as the corrected output signal of the output signal Sa of a pixel in a line sensor. Here, it is assumed that Sa is an output signal of a pixel in the line sensor that is conjugate with the lit unit light source, and Sb is an output signal of the same pixel when unit light sources adjacent to the unit light source are lit.

In FIG. 1, the description of a scanning mechanism is omitted. The scanning mechanism is similar to that of conventional slit-scanning confocal microscopes, and such a conventional scanning mechanism can directly be used in the invention.

What is claimed is:

1. A slit-scanning confocal microscope, comprising:
a slit-like light source;
an illumination optical system situated to receive light from the light source and form an image of the light source on a sample; and
an imaging optical system situated relative to sample to form an image of reflected light, transmitted light, or fluorescence light from the sample on a line sensor, the line sensor comprising multiple pixels and being disposed optically conjugate to the light source;
wherein the light source comprises multiple unit light sources, each unit light source being sized and located to be optically conjugate to a respective pixel of the line sensor.

2. The slit-scanning confocal microscope according to claim 1, further comprising a processor connected to the light source and configured to selectively turn individual unit light sources on and off according to a predetermined discrete manner.

3. The slit-scanning confocal microscope according to claim 1, further comprising a processor, wherein, if Sa is an output signal obtained from a pixel in the line sensor whenever the unit light source conjugate with the pixel is lit, and if Sb is an output signal obtained from the pixel in the line sensor whenever the unit light source conjugate with the pixel is not lit while respective unit light sources on both sides of the not-lit unit light source are lit, the processor determines a difference output signal (Sa−Sb) for use as a corrected output signal of the output signal Sa of the pixel in the line sensor.

4. The slit-scanning confocal microscope according to claim 2, wherein the light source and processor are configured such that lit unit light sources and non-lit unit light sources are arranged alternatingly.

5. The slit-scanning confocal microscope according to claim 4, wherein the processor is configured such that, if Sa is an output signal obtained from a pixel in the line sensor whenever the unit light source conjugate with the pixel is lit, and if Sb is an output signal obtained from the pixel in the line sensor whenever the unit light source conjugate with the pixel is not lit while respective unit light sources on both sides of the not-lit unit light source are lit, the processor determines a difference output signal (Sa−Sb) for use as a corrected output signal of the output signal Sa of the pixel in the line sensor.

6. The slit-scanning confocal microscope according to claim 2, wherein the processor is configured to control the light source such that unit light sources adjacent to a lit unit light source are turned off.

7. The slit-scanning confocal microscope according to claim 6, wherein the processor is configured such that, if Sa is an output signal obtained from a pixel in the line sensor whenever the unit light source conjugate with the pixel is lit, and if Sb is an output signal obtained from the pixel in the line sensor whenever the unit light source conjugate with the pixel is not lit while respective unit light sources on both sides of the not-lit unit light source are lit, the processor determines a difference output signal (Sa−Sb) for use as a corrected output signal of the output signal Sa of the pixel in the line sensor.

8. The slit-scanning confocal microscope according to claim 6, wherein the processor and light source are configured such that lit unit light sources and non-lit unit light sources are arranged alternatingly.

9. The slit-scanning confocal microscope according to claim 8, wherein the processor is configured such that, if Sa is an output signal obtained from a pixel in the line sensor whenever the unit light source conjugate with the pixel is lit, and if Sb is an output signal obtained from the pixel in the line sensor whenever the unit light source conjugate with the pixel is not lit while respective unit light sources on both sides of the not-lit unit light source are lit, the processor determines a difference output signal (Sa−Sb) for use as a corrected output signal of the output signal Sa of the pixel in the line sensor.
